(19) United States
(12) Patent Application Publication
(10) Pub. No.: US 2022/0134637 A1
(43) Pub. Date: May 5, 2022

(54) METHOD FOR PRINTING A THREE-DIMENSIONAL OPTICAL COMPONENT

(71) Applicant: LUXEXCEL HOLDING B.V., Eindhoven (NL)

(72) Inventor: Guus De Ronde, Eindhoven (NL)

(21) Appl. No.: 17/431,767

(22) PCT Filed: Feb. 19, 2020
(86) PCT No.: PCT/EP2020/054403

§ 371 Date: Aug. 18, 2021

(30) Foreign Application Priority Data
Feb. 20, 2019 (EP) 19158360.8

(51) Int. Cl. B29C 64/112; B33Y 10/00

(52) U.S. Cl. CPC B29C 64/112; B29L 2011/00; B33Y 10/00

(57) ABSTRACT

A method for printing a three-dimensional optical component (1), wherein the three-dimensional component (1) is built up from layers of printing ink which are printed at least partially one above the other in consecutive layer-printing steps, wherein during at least one layer-printing step a layer is printed in multi-pass mode, wherein the multi-pass layer (4) is divided into multiple sublayers (3) which are printed in consecutive sublayer-printing steps such that during each sublayer-printing step only part of the multi-pass layer (4) is printed and the full multi-pass layer (4) is obtained through the multiple sublayer-printing steps.

### BACKGROUND

The present invention relates to a method for printing a three-dimensional optical component, wherein the three-dimensional component is built up from layers of printing ink which are printed at least partially one above the other in consecutive layer-printing steps.

Printing three-dimensional optical components such as lenses, mirrors and the like is known from the prior art. The optical components are built up layer by layer through a targeted placement of droplets of printing ink. The droplets are ejected towards a substrate by ejection nozzles of the print head of an inkjet printer. Printing of optical components is particularly demanding due to the high accuracy required. Here, the printing accuracy of the final layers is decisive. These surface finishing layers endow the optical component with the correct three-dimensional shape as well as the required surface finish. The accuracy and perfection of surface curvature and smoothness of the component are affected to a large extend by the accuracy of the surface finishing layers that provide the optical component with its optical qualities. It is therefore crucial to avoid ripples, waves and other artefacts during the surface finishing stage. Among the factors creating such unwanted artefacts is the jetting distance between the ejection nozzles and the respective points on the surface of the optical component. Depending on the geometry of the optical component, jetting distance can differ significantly between different points on the component. In the case of a lens, for example, the jetting distance at the centre and at the periphery of the lens may differ to a great extent. This is due to the fact that droplets are never ejected perfectly straight down by the inkjet nozzles, but at a non-zero jetting angle. With increasing jetting distance, this jetting angle creates an increasing landing offset. These landing offsets show up as ripples and other unwanted artefacts on the surface of the optical component. This effect is the more severe, as the surface finishing consists of a set of consecutive finishing layers so that these artefacts add up, creating interference patterns that potentially create distortion and waviness at a local scale.

### SUMMARY

It is a purpose of the present invention to provide a method for printing a three-dimensional optical component free of unwanted artefacts that compromise the smoothness of the optical component, in particular those artefacts caused by differing landing offsets.

According to the present invention, this object is achieved by a method for printing a three-dimensional optical component, wherein the three-dimensional component is built up from layers of printing ink which are printed at least partially one above the other in consecutive layer-printing steps, such that during at least one layer-printing step a layer is printed in multi-pass mode, wherein the multi-pass layer is divided into multiple sublayers which are printed in consecutive sublayer-printing steps such that during each sublayer-printing step only part of the multi-pass layer is printed and the full multi-pass layer is obtained through the multiple sublayer-printing steps.

With this method, it is advantageously possible to print three-dimensional optical components of high optical quality and accuracy. Through division of a single layer in multiple sublayers that only cover part of the original, single layer, undesirable printing artefacts as those caused by differing jetting distances are avoided. Multi-pass printing methods are used in conventional two-dimensional printing in order to avoid banding effects and to achieve a homogeneous color density of printed images. The present invention adapts multi-pass technology to printing of at least a part of a three-dimensional structure with the aim to avoid unwanted geometrical irregularities and to achieve a three-dimensional structure of an intended geometry and shape.

In the sense of the present invention, each layer printing step preferably comprises a targeted placement of droplets of printing ink at least partially side by side. Preferably, at least one layer-printing step is followed by a curing step. During the curing step, at least part of the printed layer is exposed to irradiation, preferably with ultra-violet (UV) light. Through curing, the printing ink, preferably a monomer, stabilizes the deposited droplets, preferably through polymerization of the printing ink. Preferably, the optical component is a lens, in particular an ophthalmic lens.

Preferably, the layers or part of the layers that constitute the optically most relevant part of the optical component are printed in multi-pass mode. Through printing in multi-pass mode, optical aberration effects can be reduced or even entirely avoided in the optically most relevant parts of the component.

According to a preferred embodiment, the printing patterns of at least one sublayer of the at least one multi-pass layer is randomly generated. Preferably, all sublayers of the at least one multi-pass layer are randomly generated. In this way, eventual errors and inaccuracies are averaged out. The formation of ripples and other artefacts and the resulting interference patterns are thus advantageously avoided. Preferably, all multi-pass layers are printed with the same sublayer printing patterns.

Preferably, the printing pattern for each sublayer comprises a grid wherein each grid cell corresponds to a voxel, i.e. a unit volume, of the sublayer. Grid cells are color coded to contain information about whether a droplet of printing ink is to be deposited at the corresponding voxel. E.g. the grid cells are either black or white, wherein black grid cells correspond to voxels of the sublayer on which a droplet of printing ink is to be deposited during the sublayer printing step and white grid cells correspond to voxels on which no printing ink is to be deposited during the sublayer printing step. Preferably, the same printing pattern is used for at least two sublayers printed in a first and a second sublayer-printing step of the at least one multi-pass layer, wherein droplets are deposited at voxels corresponding to black grid cells during the first sublayer-printing step and droplets are deposited at voxels corresponding to white grid cells during the second sublayer printing step.

In a preferred embodiment, the printing pattern of at least one sublayer of the at least one multi-pass layer is generated through conversion of a greyscale image into a black-and-white pattern, e.g. through halftoning.

In a preferred embodiment, random generation of the sublayer printing pattern comprises a step of converting a greyscale image to a black-and-white pattern using any of the known algorithms for this conversion. The conversion of the greyscale image into a black-and-white pattern is preferably carried out through halftoning. Halftoning comprises a simulation of the continuous greyscale image through a pattern of black dots of either varying size and/or spacing on a white background.

According to another preferred embodiment, the printing pattern of at least one sublayer is rotated by a defined angle and used as a printing pattern at least a second sublayer of the same or a different multi-pass layer.

According to a preferred embodiment, the at least one multi-pass layer is printed in N sublayer-printing steps and each sublayer covers an Nth of the surface of the full multi-pass layer. Preferably, N is smaller than 10, particularly preferably N=3. In this way, a third of the multi-pass layer is printed during each sublayer-printing step and an optimal trade-off between speed and accuracy is achieved.

According to a preferred embodiment, between 4 and 12 layers are printed in multi-pass mode.

According to a preferred embodiment, the three-dimensional optical component is rotated by a defined angle after at least one layer-printing step. Preferably, the defined angle is smaller than 180°, particularly preferably the defined angle is 20°.

According to a preferred embodiment, the at least one multi-pass layer is printed during the final layer-printing steps. In this way, an efficient and effective surface finishing method is provided that endows the printed optical component with a smooth surface free of unwanted artefacts. As the final, surface finishing layers are crucial for the overall quality and accuracy of the optical component, an optical component of enhanced quality and accuracy is thus advantageously provided. Preferably, the final layer-printing steps comprise the last 20 layers. The final layer-printing steps may be carried out at a different printing speed than the remaining layer-printing steps. Preferably, the final layers are cured with different curing properties, e.g. with a different curing time, than the remaining layers.

According to a preferred embodiment, at least a first and a second layer are printed in multi-pass mode according to any of the preferred embodiments outlined above, wherein the multi-pass method of the first multi-pass layer differs from the multi-pass method of the second multi-pass layer, i.e. the different multi-pass methods are mixed in printing the three-dimensional optical component. Through mixing of multi-pass schemes and/or choosing these schemes depending on the requirements of the respective layer as well as of the overall printing process, e.g. with regard to speed and accuracy, printing efficiency and accuracy can be advantageously optimized and tuned to the application at hand.

### BRIEF DESCRIPTION OF THE DRAWINGS

FIG. 1 schematically illustrates a printing method according to an exemplary embodiment of the present invention.

FIG. 2 schematically illustrates an optical component printed with a printing method according to an exemplary embodiment of the present invention as compared to an optical component printed with a printing method according to the state of the art.

FIG. 3 schematically illustrates different methods for the generation of randomized printing patterns for sublayer printing.

FIG. 4 schematically illustrates different methods for the generation of printing patterns for sublayer printing.

### DETAILED DESCRIPTION

The present invention will be described with respect to particular embodiments and with target to certain drawings but the invention is not limited thereto but only by the claims. The drawings described are only schematic and are non-limiting. In the drawings, the size of some of the elements may be exaggerated and for illustrative purposes may not be drawn to scale.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

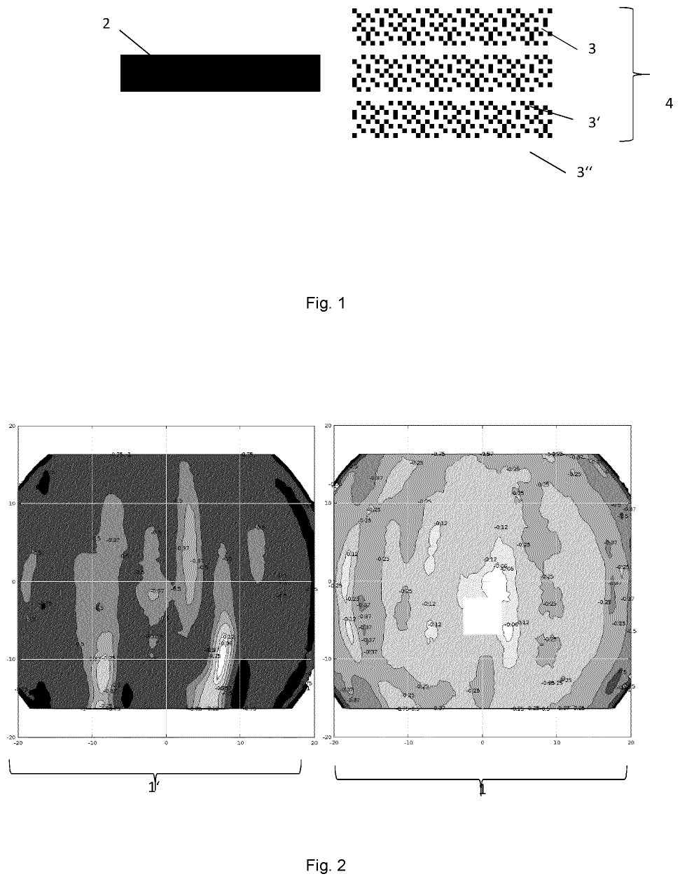

In FIG. 1 a method for printing a three-dimensional optical component 1 according to an exemplary embodiment of the present invention is schematically illustrated. The optical component 1 is printed from layers of printing ink in consecutive layer printing steps. During each layer printing step, a layer of printing ink 2 is obtained through a targeted placement of droplets of printing ink. The droplets are ejected from printing nozzles of a print head of an inkjet printer, preferably towards a substrate. In printing optical components, accuracy and prevision is of increased importance. Particularly important for the overall quality of the optical component is the printing of the final layers. These surface finishing layers endow the optical component with its three-dimensional shape and the required surface finish. Ripples, waves and other artefacts that occur during printing of the final layers are particularly detrimental. Among the effects creating such unwanted artefacts is the jetting distance, i.e. the distance between printing nozzle and substrate or previously deposited layer, respectively. As droplets are ejected at a non-zero jetting angle, a landing offset is created. Here, the jetting angle is measured as deviation from an ejection straight down, i.e. parallel to the gravitational field. The landing offset increases with the distance of the nozzles from the substrate or previously printed layer, respectively. For a three-dimensional optical component 1, differing landing offsets across its surface result. In the case of the optical component being a lens, the landing offset in the centre of the lens may differ significantly from the landing offset at its edges and periphery. These differences show up as ripples and other unwanted artefacts on the optical component 1. As surface finishing comprises a set of consecutive surface finishing layers, these effects add up, creating interference patterns and potentially distortions and waviness at a local scale. In order to avoid suchlike artefacts, the present invention provides a method according to which at least one layer 4 is printed in multi-pass mode. Preferably, the final layers are printed in multi-pass mode. Preferably, the final layers comprise the last 20 layers. Preferably, between four and twelve, particularly preferably eight, final layers are printed in multi-pass mode. In applying multi-pass mode to the final, surface finishing layers, the particularly detrimental artefacts on the surface of the optical component 1 are reduced or avoided altogether. Additionally, it is preferred to use different printing configurations, e.g. printing speed and curing properties, for the final, surface finishing layers.

Printing in multi-pass mode comprises dividing the layer 4 in N sublayers 3, 3′, 3″, wherein N is preferably smaller than ten, particularly preferably three. The sublayers 3, 3′, 3″ are printed in sublayer printing steps such that during each sublayer printing step only part of the original layer 2 is printed but the full layer 2 is recovered after execution of the N sublayer printing steps. Each sublayer is printed with a defined, preferably randomly generated, sublayer printing pattern. For example, the one-pass surface layer 2 is divided into three complimentary patterned sublayers 3, 3′, 3″. During each sublayer printing step, a sublayer 3 (3′, 3″ respectively) is printed. The corresponding printing pattern comprises 33,33% black and 66,66% white pixels. Here, black pixels correspond to points on the substrate or previously deposited layer, respectively, at which a droplet of printing ink is deposited during the sublayer printing step. Preferably, the pattern is designed such that the distance between simultaneously ejected droplets is as large as possible. Once the sublayer 3, 3′, 3″ is deposited, it coalesces into a thinner layer. Splitting the one pass full layer print 2 into N, e.g. three, complementary patterned sublayers allows a longer merging time of the sublayers. This in turn advantageously results in an increased surface smoothness and ultimately in an improved optical quality of the component 1. Preferably, the same sublayer printing patterns are used for printing each multi-pass layer 4. The randomization of the printing patterns of the sublayers can be equal but periodically translated or different for each sublayer printing step. It is only mandatory to avoid the generation of regular patterns. Additionally, the three-dimensional optical component 1 is preferably rotated by a defined angle after at least one layer-printing step. Through rotation the effect of printing errors and unwanted artefacts is advantageously averaged out. An accumulation of such errors and artefacts is hence avoided, the emergence of e.g. interference patterns suppressed. Rotation is particularly preferably carried out during printing of the final, surface finishing layers. These may or may not comprise some or all of the multi-pass layers 4. Preferably, however, rotation is carried out after printing of at least one multi-pass layer 4. The preferred defined rotation angle is 20°.

In FIG. 2 an optical component 1 printed with a printing method according to an exemplary embodiment of the present invention as compared to an optical component 1′ printed with a printing method according to the state of the art is schematically illustrated. The printing methods employed for the production of the optical components 1, 1′ differ by printing of the final, surface finishing layers. The final, surface finishing layers of the optical component 1′ have been printed in single pass mode, i.e. each layer has been printed in a single layer printing step according to the state of the art method. In contrast to this, the final, surface finishing layers of the optical component 1 have been printed according to an exemplary embodiment of the present inventions such as described in detail in FIG. 1. That means, the final, surface finishing layers of the optical component 1 have been printed in multi-pass mode. Shown are the deviations from the desired optical power, on the left for the conventionally produced component 1′, on the right for the component 1 produced to an exemplary embodiment of the present invention. As can be seen from the diagrams, the present method results in an optical component 1 of increased optical accuracy as compared to those obtained by state of the art single-pass printing methods.

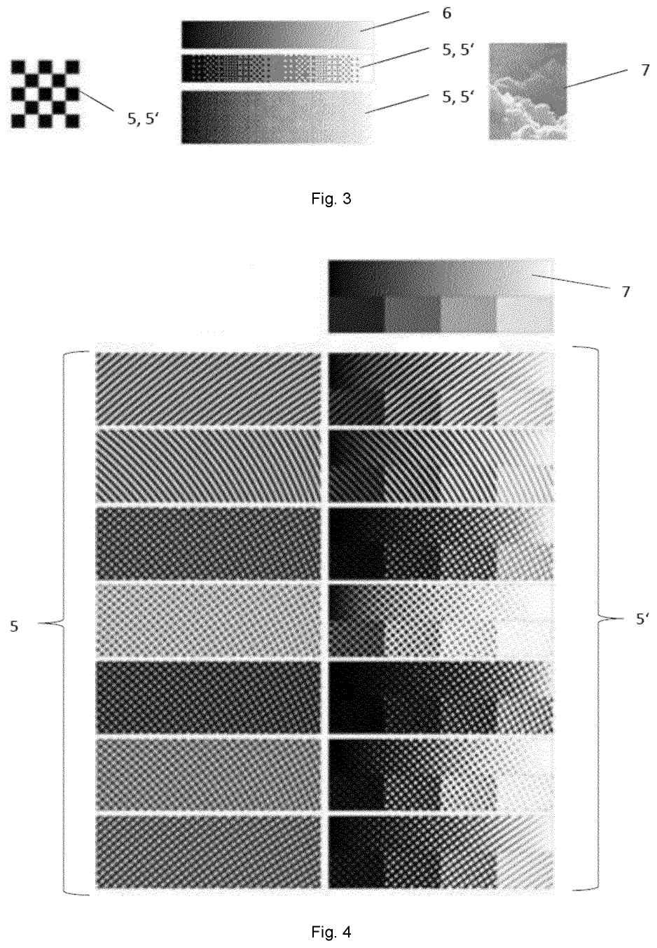

In FIG. 3 different methods for the generation of randomized printing patterns for sublayer printing are schematically illustrated. The printing patterns 5, 5′ of the sublayers 3 of a multi-pass layer 4 are chosen such that they cover the entire multi-pass layer 4 when combined. This is most easily achieved through a checkerboard scheme as shown in the left panel of FIG. 3. For the checkerboard scheme a first and second sublayer 3, 3′ are printed from printing pattern 5 in a first and second sublayer-printing step, respectively. Grid cells of black color in the printing pattern 5 correspond to voxels in which droplets of printing ink are deposited in the first sublayer-printing step. Grid cells of white color in the printing pattern 5 correspond to voxels in which droplets of printing ink are deposited in the second sublayer-printing step. This scheme generalizes to an arbitrary number of sublayers, e.g. through an initial division of the voxels of the multi-pass layer 4 into a first set and a second set, wherein the scheme described above is applied to the first and the second set separately. Alternatively, the initial checkerboard comprises black and white super-grid cells consisting of more than one grid cell each, e.g. consisting of four grid cells. From this, sublayer printing patterns 5, 5′ are derived. Either or both of these sublayer printing patterns 5, 5′ is preferably further partitioned into a checkerboard-like grid wherein each grid cell corresponds to a single voxel, resulting in printing patterns for a second, third and eventually fourth sublayer, respectively.

Alternatively or additionally, the sublayer printing patterns 5 are preferably randomly generated from a greyscale image 6 as shown in the middle panel of FIG. 3. To this end, an x % grey is converted into a pattern of black and white grid cells, preferably through halftoning. This conversion may be carried out by any of the known algorithms. Different algorithms can be used to generate differing printing patterns 5, 5′ from the same greyscale image 6. This greyscale scheme easily generalizes to more than two sublayers 3, 3′ per multi-pass layer 4, in particular through application of the schemes outlined in the previous paragraph.

Alternatively or additionally, the greyscale scheme of the previous paragraph is combined with a base picture 7 comprising a random pattern as shown in the right panel of FIG. 3. The base picture 7 preferably comprises a greyscale picture of a random pattern. Random patterns comprise clouds, waves, smoke and the like. Preferably, the base picture 7 comprises a small range of grey scale, e.g. between 20% and 40%. This base picture 7 is preferably converted into a black-and-white pattern of grid cells as described above, e.g. through halftoning, resulting in printing patterns 5, 5′ for two sublayers 3, 3′. The scheme generalizes to more than two sublayers 3 through application of the schemes outlined in the description of the left panel of FIG. 3.

In FIG. 4 methods for generating different printing patterns 5′ are schematically illustrated. In particular, FIG. 4 schematically illustrates the different printing patterns 5′ that can be obtained from a combination of greyscale conversion into black-and-white grids, in particular through halftoning, with example image patterns 5 shown in the left column and a rotation of these image patterns 5. A greyscale base picture 7 is combined with a transformed, in particular rotated, pattern 5 resulting in the displayed randomized printing patterns 5′. Randomized printing patterns 5′ are particularly effective in avoiding ripples and other irregularities as resulting e.g. from landing offsets. Through using different printing patterns 5′ for different multi-pass layers 4, the randomization effect is even more pronounced. In this way, particularly smooth surfaces can be printed. This is particularly important for three-dimensional optical components where ripples and other unwanted irregularities result in unwanted aberrations.

### KEY TO FIGURES

1 Optical component
2 Single-pass layer
3 Sublayer
4 Multi-pass layer
5 Printing pattern
6 Greyscale image
7 Base picture

1. A method for printing a three-dimensional optical component, wherein the three-dimensional component is built up from layers of printing ink which are printed at least partially one above the other in consecutive layer-printing steps;
wherein during at least one layer-printing step a multi-pass layer is printed in multi-pass mode;
wherein the multi-pass layer is divided into multiple sublayers which are printed in consecutive sublayer-printing steps such that during each sublayer-printing step only part of the multi-pass layer is printed and the full multi-pass layer is obtained through the multiple sublayer-printing steps;
wherein the multi-pass layer is printed during final layer-printing steps;
wherein the final layer-printing steps comprise the last 20 layers; and
wherein the final layer-printing steps are carried out at a different printing speed than the remaining layer-printing steps.

2. The method according to claim 1, wherein a printing pattern of at least one sublayer of the multi-pass layer is randomly generated.

3. The method according to claim 1, wherein a printing pattern of at least one sublayer of the multi-pass layer is generated through conversion of a greyscale image into a black-and-white pattern.

4. The method according to claim 1, wherein all multi-pass layers are printed with the same sublayer printing patterns.

5. The method according to claim 1, wherein the multi-pass layer is printed in N sublayer-printing steps and each sublayer covers an Nth of a surface of the full multi-pass layer.

6. The method according to claim 5, wherein N is smaller than 10.

7. The method according to claim 1, wherein between 4 and 12 multi-pass layers are printed in multi-pass mode.

8. The method according to claim 1, wherein the three-dimensional optical component is rotated by a defined angle after at least one layer-printing step.

9. The method according to claim 8, wherein the defined angle is 20°.

10.-12. (canceled)

13. The method according to claim 1, wherein at least one layer-printing step is followed by a curing step.

14. The method according to claim 13, wherein final layers are cured with different curing properties than remaining layers.

15. The method according to claim 1, wherein each layer-printing step comprises a targeted placement of droplets of printing ink at least partially side by side.

16. The method according to claim 3, wherein the printing pattern of at least one sublayer of the multi-pass layer is generated through halftoning.

17. The method according to claim 6, wherein N=3.
